(19) United States
(12) Patent Application Publication
(10) Pub. No.: US 2025/0340106 A1
(43) Pub. Date: Nov. 6, 2025

(54) HYBRID ELECTRIC VARIABLE TRANSMISSION FOR ALL-WHEEL DRIVE OFF-ROAD CAPABLE VEHICLE

(71) Applicant: FCA US LLC, Auburn Hills, MI (US)

(72) Inventors: Sachin Bhide, Rochester Hills, MI (US); Omkar Rane, Lake Orion, MI (US)

(21) Appl. No.: 18/653,049

(22) Filed: May 2, 2024

(51) Int. Cl. B60K 6/547; B60K 6/365; B60K 6/52; B60K 17/34; F16H 3/64

(52) U.S. Cl. CPC B60K 6/547; B60K 6/365; B60K 6/52; B60K 17/34; F16H 3/64; B60Y 2200/92; F16H 2200/0017; F16H 2200/2007; F16H 2200/2035

(57) ABSTRACT

An electrified powertrain that generates and transfers drive torque to a driveline of a hybrid vehicle includes a first electric motor, a second electric motor, an internal combustion engine (ICE), a first and second planetary gear set, and a first and a second clutch. The first planetary gear set includes a first sun gear, a first carrier and a first ring gear. The first sun gear is coupled to the first electric motor output. The first ring gear is coupled to the second electric motor output and the first carrier is selectively coupled to the ICE output. The second planetary gear set includes a second sun gear, a second carrier and a second ring gear. The second sun gear is coupled to the first ring gear. The second carrier is coupled to the driveline. The first clutch selectively fixes the second ring gear from rotating.

### FIELD

The present application generally relates to hybrid electric vehicles and, more particularly, to a hybrid electric variable transmission for an all-wheel drive off-road capable vehicle.

### BACKGROUND

A hybrid electric vehicle includes an internal combustion engine (ICE), at least one high-voltage battery system and at least one electronic drive module having an electric motor and associated electrified drive gearbox assembly. Some electrified drive gearbox assemblies include one or more than one fixed gear for shifting. Electronically variable transmissions (EVT's) are another example for delivering drive torque between a prime mover (ICE, electric motor, etc.) and a drivetrain. EVT systems are not fixed gears and can provide infinite ratios providing improved efficiency. EVT's are generally associated with front wheel drive vehicles. It can be challenging to provide increased efficiencies and lower emissions while meeting performance demands. Accordingly, while such gearbox assemblies do work well for their intended purpose in hybrid electric vehicles, there is a desire for improvement in the relevant art.

### SUMMARY

According to one example aspect of the invention, an electrified powertrain that generates and transfers drive torque to a driveline of a hybrid vehicle includes a first electric motor, a second electric motor, an internal combustion engine (ICE), a first and second planetary gear set, and a first and a second clutch. The first planetary gear set includes a first sun gear, a first carrier and a first ring gear. The first sun gear is coupled to the first electric motor output. The first ring gear is coupled to the second electric motor output and the first carrier is selectively coupled to the ICE output. The second planetary gear set includes a second sun gear, a second carrier and a second ring gear. The second sun gear is coupled to the first ring gear. The second carrier is coupled to the driveline. The first clutch selectively fixes the second ring gear from rotating. The second clutch selectively fixes the first and second ring gear for rotating together.

In some implementations, the electrified powertrain further includes an ICE clutch that selectively couples the ICE output to the first carrier. In examples, the ICE clutch is a one-way clutch.

In some implementations, the electrified powertrain further includes a motor speed reducer disposed between the second electric motor output and the first ring gear.

In some implementations, the electrified powertrain further includes a final drive ratio disposed between the second carrier and the driveline.

In additional features, a first gear is selected based on closing of the first clutch and opening the second clutch. In examples, the first gear is a low gear. In additional examples, the first gear provides a drive ratio above 4.

In additional features, the second electric motor provides a ground ratio of above 30 in the first gear.

In additional features, wherein a fourth gear is selected based on closing of the second clutch and opening the first clutch.

In additional features, the fourth gear is a regular gear that provides a drive ratio of 1:1.

In other features, the hybrid electric vehicle is all-wheel drive.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a hybrid electric vehicle that implements an EVT for an all-wheel drive vehicle according to various principles of the present application;

FIG. 2 is a plot illustrating various wheel torque requirements for corresponding low speed applications according to one example of the present application;

FIG. 3 is a schematic illustration of the EVT for an all-wheel drive vehicle of FIG. 1 according to one example of the present application; and

FIG. 4 is chart illustrating clutch applications and drive ratios for various gears of the EVT according to one example of the present application.

### DESCRIPTION

As mentioned above, EVT systems are generally associated with front wheel drive vehicles. It can be challenging to provide increased efficiencies and lower emissions and performance demands. The instant disclosure provides an EVT for an all-wheel drive vehicle. The EVT includes a second planetary gear set downstream of a first planetary gear set. A first ring gear of the first planetary gearset is coupled to a second sun gear of the second planetary gear set. A second carrier of the second planetary gear set is coupled to an output shaft that drives the drivetrain through a final drive ratio. The EVT disclosed herein provides an available low gear for high torque at low speeds, particularly suitable for off-roading conditions.

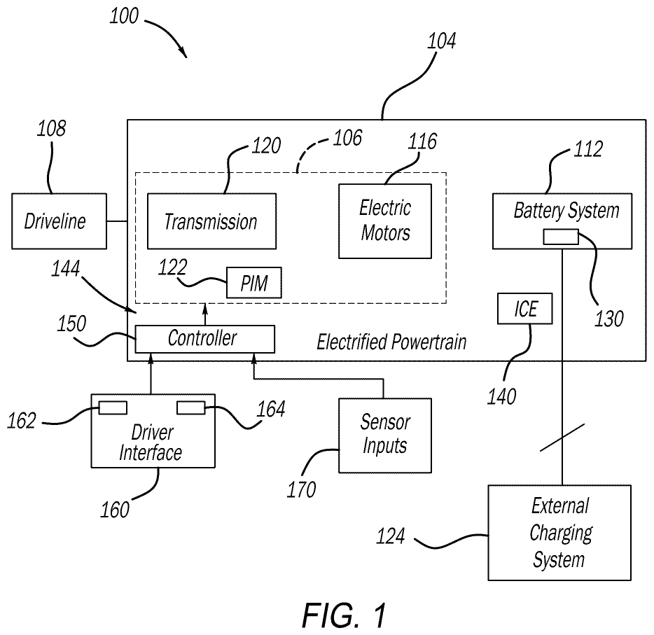

Referring now to FIG. 1, a functional block diagram of an example hybrid electric vehicle 100 (also referred to herein as “vehicle 100”) according to the principles of the present application is illustrated. The vehicle 100 includes an electrified powertrain 104 having an electrified drive module (EDM) 106 configured to generate and transfer drive torque to a driveline 108 for vehicle propulsion. The EDM 106 generally includes one or more electrified drive units or motors 116 (e.g., electric traction motors), an electrified drive gearbox assembly or transmission 120, and power electronics including a power inverter module (PIM) 122. As will become appreciated herein, the exemplary powertrain 104 includes a first electric motor 116A and a second electric motor 116B.

The electric motors 116 are connected via the PIM 122 to a high voltage battery system 112 for powering the electric motors 116. The battery system 112 is selectively connectable (e.g., by the driver) to an external charging system 124 (also referred to herein as “charger 124”) for charging of the battery system 112. The battery system 112 includes at least one battery pack assembly 130. The electrified powertrain 104 is a hybrid powertrain that additionally includes an internal combustion engine (ICE) 140. As will be described herein, the electric motors 116 and the ICE 140 cooperate to provide drive torque to the driveline 108.

A vehicle control system 144 includes a controller 150 that can provide various inputs to the EDM 106 including torque requests based on signals received from a driver interface 160. In examples, the driver interface 160 can include a drive input device, e.g., an accelerator pedal 162, for providing a driver input, e.g., a torque request, to the controller 150 and ultimately the EDM 106. The driver interface 160 can further include a human machine interface (HMI) 164 for displaying driver information and receiving driver requests. The HMI 164 can include any interface that receives an input from the driver indicative of a desire of the driver to alter any parameter of the powertrain 104 such as a torque output. In some examples, the HMI can be arranged on a steering wheel of the hybrid electric vehicle 100.

While the vehicle control system 144 is shown as a single controller 150, it will be appreciated that more controllers and/or modules, such as a supervisory electrified vehicle control module, a battery control module, a motor control module and a chassis stability module, can be utilized to control various vehicle components of the hybrid electric vehicle 100. In this regard, various controllers and modules are configured to communicate with each other, utilizing different sensor inputs 170 and calculated parameters as disclosed herein for controlling operation of the powertrain 104.

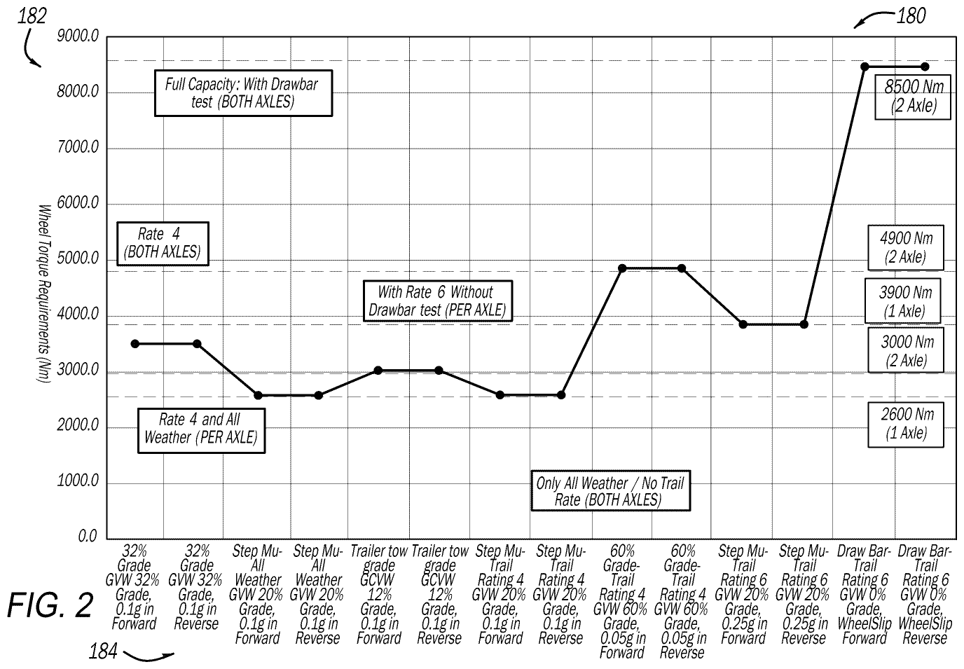

With additional reference now to FIG. 2, a plot 180 illustrating various wheel torque requirements 182 for corresponding low speed applications 184 according to one example of the present disclosure is shown. It will be appreciated that the various wheel torque requirements and low speed applications are merely exemplary and that the EVT transmission 120 can be configured differently for satisfying additional or alternative criteria within the scope of this disclosure. As shown, to satisfy some criteria, the hybrid electric vehicle 100 needs a minimum of 3900 Nm per axle, or 8500 Nm collectively (both axles).

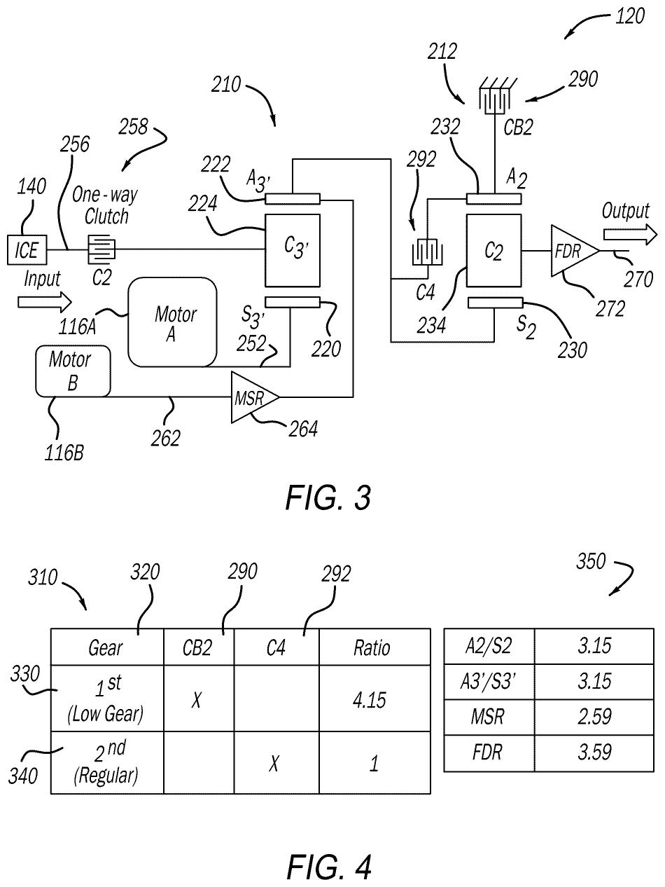

With additional reference now to FIG. 3, the EVT 120 will be further described. As shown, the EVT 120 is driven by the electric motors 116A, 116B and the ICE 140. The EVT 120 includes two planetary gear sets 210 and 212. The first planetary gear set 210 includes a first sun gear 220, a first annulus or ring gear 222 and a first carrier 224. The second planetary gear set 212 includes a second sun gear 230, a second annulus or ring gear 232 and a second carrier 234.

An ICE output 256 of the ICE 140 is selectively coupled to the first carrier 224 through an ICE clutch 258. The ICE clutch 258 can be a one-way clutch. In examples, the ICE clutch 258 can allow the second electric motor 116B to perform reverse gradability maneuvers. A first electric motor output 252 of the first electric motor 116A is coupled to the first sun gear 220. A second electric motor output 262 of the second electric motor 116B is selectively coupled with the first ring gear 222 through a motor speed reducer 264.

The second planetary gear set 212 is configured downstream of the first planetary gear set 210. In this regard, the first ring gear 222 of the first planetary gear set 210 is coupled to the second sun gear 230 of the second planetary gear set 212. The second carrier 234 of the second planetary gear set 212 is coupled to an output shaft 270 that drives the driveline 108 through a final drive ratio 272.

A first clutch 290 actuates between open and closed positions to selectively fix the second ring gear 232 from rotating. In the example provided, engaging the first clutch 290 provides an additional drive ratio of 4.15. The additional drive ratio can satisfy the elevated torque requirements shown in FIG. 2.

The exemplary arrangement ensures an electric motor 116B to ground ratio of around 38.55. The torque multiplication with the FDR 272 provides engine to ground ratio of about 11.3 for the mechanical path with adequate reaction torque from the first electric motor 116A is available. Again, the values listed are merely exemplary and are used to denote torque advantages. In low or first gear, described below, prior art EVT original hardware has a limitation of around 3500 Nm at the output shaft. With the EVT 120, the torque increases to around 14,525 Nm.

A second clutch 292 actuates between open and closed positions to selectively fix the second ring gear 232 for rotation with the first ring gear 222. In the example provided, engaging the second clutch 292 can provide a 1:1 gear ratio, for normal operating conditions. This mode can be used for a majority of situations when low or first gear is not needed.

With continued reference to FIG. 3 and additional reference to FIG. 4, operation of the EVT 120 according to principles of the present disclosure will be described. FIG. 4 illustrates a shifting table 310. The shifting table 310 illustrates gears 320 available with the EVT 120. The gears 320 include a first or low gear 330, and a fourth or regular gear 340. The fourth gear 340 is selected for most driving conditions where increased low end torque is not needed.

The first gear 330 is selected by closing the clutch 290 while opening the clutch 292. The second gear 340 is selected by closing the clutch 292 while opening the clutch 290. A gear ratio table 350 illustrates various ratios associated with the planetary gear sets 210, 212, the MSR 264 and the FDR 272. Other values are contemplated.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electrified powertrain that generates and transfers drive torque to a driveline of a hybrid electric vehicle, the electrified powertrain comprising:
a first electric motor having a first electric motor output;
a second electric motor having a second electric motor output;
an internal combustion engine (ICE) having an ICE output;
a first planetary gear set including a first sun gear, a first carrier and a first ring gear, wherein the first sun gear is coupled to the first electric motor output, the first ring gear is coupled to the second electric motor output and the first carrier is selectively coupled to the ICE output;
a second planetary gear set including a second sun gear, a second carrier and a second ring gear, the second sun gear is coupled to the first ring gear, the second carrier is coupled to the driveline;
a first clutch that selectively fixes the second ring gear from rotating; and
a second clutch that selectively fixes the first and second ring gears for rotating together.

2. The electrified powertrain of claim 1, further comprising:
an ICE clutch that selectively couples the ICE output to the first carrier.

3. The electrified powertrain of claim 2, wherein the ICE clutch is a one-way clutch.

4. The electrified powertrain of claim 2, further comprising:
a motor speed reducer disposed between the second electric motor output and the first ring gear.

5. The electrified powertrain of claim 2, further comprising:
a final drive ratio disposed between the second carrier and the driveline.

6. The electrified powertrain of claim 2, wherein a first gear is selected based on closing of the first clutch and opening the second clutch.

7. The electrified powertrain of claim 6, wherein the first gear is a low gear.

8. The electrified powertrain of claim 7, wherein the first gear provides a drive ratio above 4:1.

9. The electrified powertrain of claim 8, wherein the driveline provides a torque above 14,000 Nm in the first gear.

10. The electrified powertrain of claim 6, wherein the second electric motor provides a ground ratio of above 30 in the first gear.

11. The electrified powertrain of claim 2, wherein a second gear is selected based on closing of the second clutch and opening the first clutch.

12. The electrified powertrain of claim 11, wherein the second gear is a regular gear that provides a drive ratio of 1:1.

13. The electrified powertrain of claim 1, wherein the hybrid electric vehicle is an all-wheel drive vehicle.
